(19) United States
(12) Patent Application Publication
(10) Pub. No.: US 2012/0118417 A1
(43) Pub. Date: May 17, 2012

(54) METHOD AND APPARATUS FOR PUMPING CONCRETE TO A FORM STRUCTURE AT ELEVATED HEIGHTS

(75) Inventors: John P. Huchko, Doylestown, PA (US); Mark W. Fellon, Easton, PA (US)

(73) Assignee: HAMON CUSTODIS, INC., Somerville, NJ (US)

(21) Appl. No.: 13/295,253

(22) Filed: Nov. 14, 2011

Related U.S. Application Data
(60) Provisional application No. 61/456,842, filed on Nov. 12, 2010.

(51) Int. Cl. F15B 13/00; B66C 7/00

(52) U.S. Cl. 137/615; 212/225

(57) ABSTRACT

A crane assembly for delivering a concrete mixture to increasing heights of an elevated structure includes a primary pipeline that receives the concrete mixture from a source of the concrete mixture. A mast supports the primary pipeline in a vertical direction. A boom extends radially outwardly from the mast, and a jib is supported by the boom at an intersecting point on the boom. A secondary pipeline is rotationally affixed to the primary pipeline and extends radially outwardly from the primary pipeline along the boom to the jib. The secondary pipeline is pivotal around the mast along with the boom. The jib is angularly displaceable from the boom at the intersecting point for directing the secondary pipeline to a location spaced from the primary pipeline.

The present application claims priority to U.S. Provisional Patent Application No. 61/456,842 filed Nov. 12, 2010.

### FIELD OF THE INVENTION

The present application relates generally to a method of transferring a concrete mixture. More specifically, the present invention relates to transferring a concrete mixture to increasing heights of concrete structure.

### BACKGROUND

Advancements in the manufacture of annular hyperbolic cooling towers have not occurred in years. Techniques used to deliver concrete mixes to ever increasing height of up to 600 feet have been found unsafe. Prior application of a secondary placement boom used with a main boom of the tower crane did not fix one end of the secondary boom, but merely allowed a secondary placement boom be suspended from a cable extending from a main boom. One such example is disclosed in U.S. Pat. No. 4,374,790, METHOD AND APPARATUS FOR PUMPING CONCRETE TO FORM STRUCTURE AT ELEVATED HEIGHTS. This arrangement has proven unsafe because the secondary boom was allowed to sway with the external force of the pumping action and thrust of the concrete in the conveyance pipe. Such prior equipment modification is no longer approved by manufacturers of equipment used for construction. There has been no development to solve this problem to facilitate the construction of, for example, an annular hyperbolic cooling tower.

Additional problems with existing equipment used to pump a concrete mixture to hyperbolic cooling towers are known. The construction of hyperbolic cooling towers require concrete mixture be delivering evenly around 360°, or complete circumference of the tower wall. Known prior art delivery devices are not capable of delivering the concrete mixture in a continuous circumferential manner because the concrete mixture delivery pipeline is not capable of 360° of rotation. Furthermore, these apparatus are only capable of delivering concrete mixture requiring secondary cranes to lift necessary construction equipment to desired heights.

Therefore, a need exists for a concrete mixture delivery device that is capable of accurately and efficiently delivering the mixture to increasing heights of a hyperbolic cooling tower without being subject to the limitations of known prior art delivery devices.

### SUMMARY OF THE INVENTION

The following is an improved method and apparatus for pumping concrete using a boom tower crane and a secondary placement jib. A crane assembly for delivering a concrete mixture to increasing heights of an elevated structure includes a primary pipeline that receives the concrete mixture from a source of the concrete mixture. A mast supports the primary pipeline in a vertical direction. A boom extends radially outwardly from the mast, and a jib is supported by the boom at an intersecting point on the boom. A secondary pipeline is rotationally affixed to the primary pipeline and extends radially outwardly from the primary pipeline along the boom to the jib. The secondary pipeline is pivotal around the mast along with the boom. The jib is angularly displaceable from the boom at an intersecting point for directing the secondary pipeline to a location spaced from the primary pipeline.

The concrete mixture delivery device of the present invention solves the problem associated with the prior art designs by increasing the accuracy of the radial delivery of the concrete mixture through the increased degree of movement of the jib. The jib provides further degrees of radial extension simultaneous with increased range of height due to the unique interaction between the boom and the jib. Furthermore, the boom, and therefore, the jib pivot 360° providing full circumferential delivery of concrete mixture increasing the efficiency and speed by which the mixture is delivered.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 shows a side view of a hyperbolic cooling tower;

FIG. 2 shows a side view of the crane assembly of the present invention;

FIG. 3 shows a side view of intersection of the primary and secondary pipeline; and

FIG. 4 shows a schematic of the range of motion of the cranes assembly of the present invention.

### DETAILED DESCRIPTION OF THE INVENTION

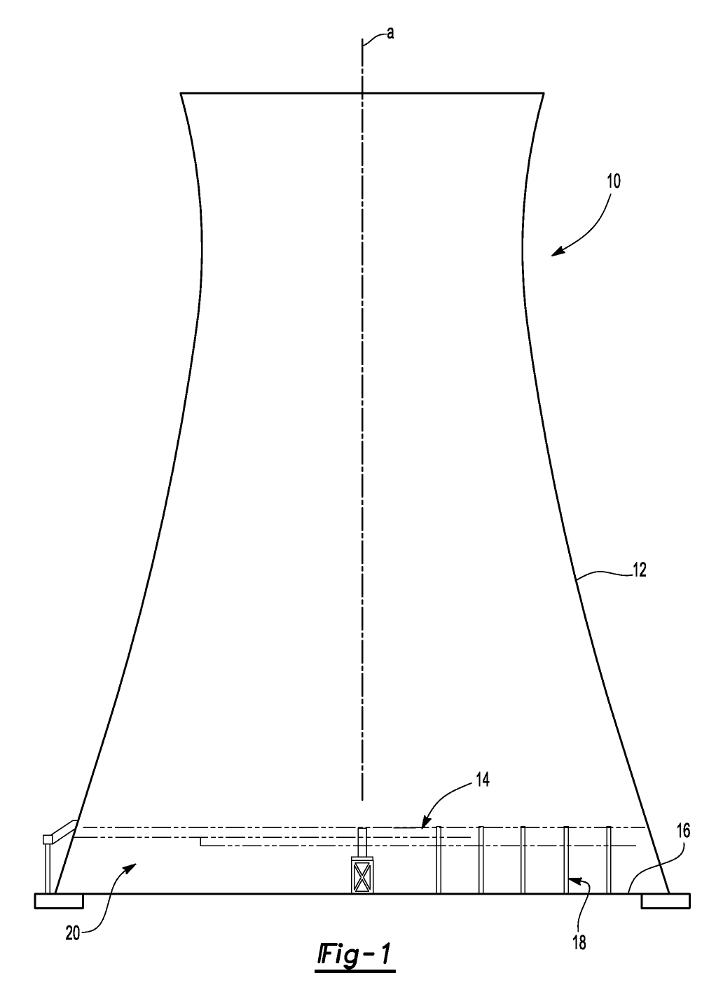

Hyperbolic cooling towers of the type shown at 10 in FIG. 1 are widely used in the energy industry to lower the temperature of the cooling water used to operate the turbines which produce energy. The natural draft cooling tower 10 is defined by a hyperbolic-shaped, annular wall 12 that encircles an axis a to define a cooling chamber 14.

The annular wall 12 is spaced from the ground 16 by a plurality of supports 18 creating an opening 20 through which air is drawn into the cooling chamber 14. The annular wall 12 is formed of concrete poured into a form work system at incrementally increasing heights of up to 600 feet from the ground 16 or base. It should be obvious to those of ordinary skill in the art that the annular wall 12 defines a changing radius from axis a as the height of the tower 10 increases to generate a desirable flow of cooling air through the cooling tower 10. The wall 12 is constructed of reinforced concrete made by pouring a concrete mixture into formwork around structural reinforcements. The concrete mixture must be delivered to increasing heights of the tower 10 to construct the wall 12.

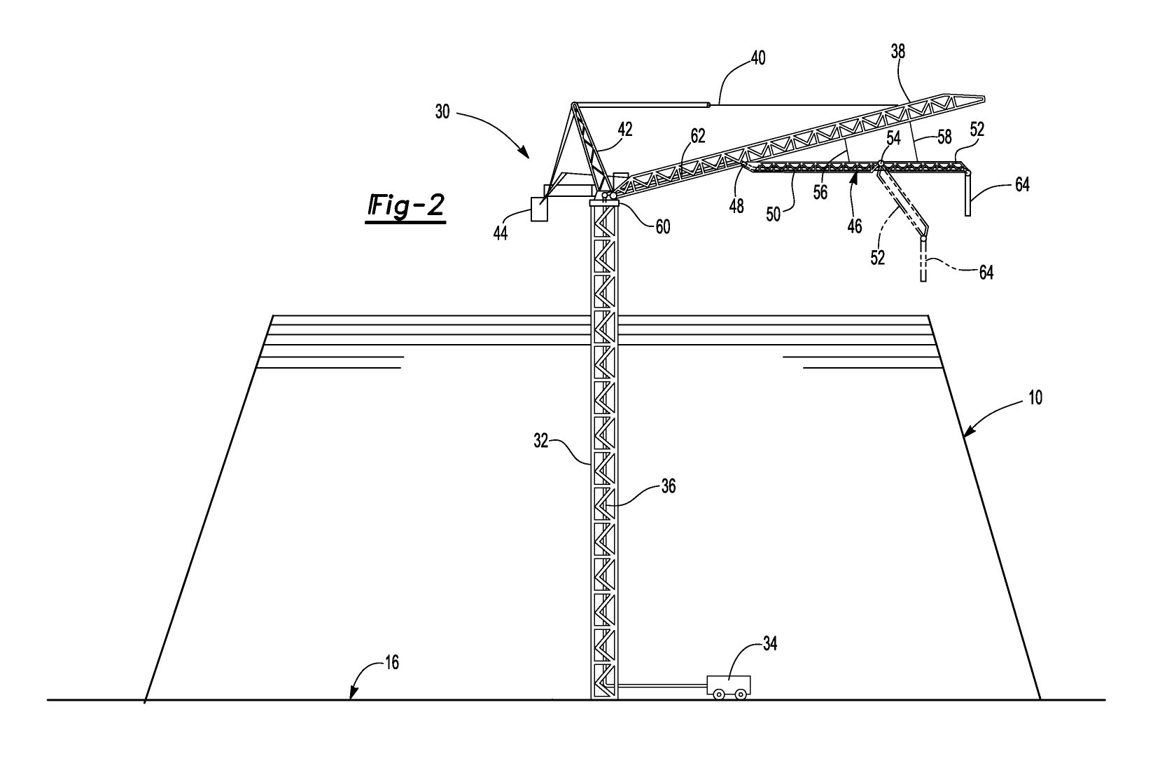

Referring to FIG. 2, a crane assembly of the present invention is generally shown at 30. The crane assembly 30 includes a mast 32 that rises vertically from ground level 16. The mast 32 is positioned generally at the axis a of the hyperbolic cooling tower 10. A source of concrete mixture includes a concrete mixture pump 34 for transferring the concrete mixture to a primary pipeline 36 that is supported in a vertical orientation by the mast 32 of the crane assembly 30 in a vertical direction. Therefore, the concrete mixture is transferred through the primary pipeline to increasing heights of the mast 32 as the wall 12 of the hyperbolic cooling tower 10 increases in height.

A boom 38 extends radially outwardly from the mast 32. The boom 38 is supported by boom cable 40 via boom cable support 42 and counterweight 44, and, in this embodiment, terminates at a proximal end at the mast. A winch or equivalent device (not shown) controls the length of the boom cable 40 to in turn control the angular relationship of the boom 38 relative to the mast 32.

A jib 46 is supported by the boom 38 at an intersecting point 48. The jib 46 is capable of pivoting relative to the boom 38 at the intersecting point 48, the purpose of which will become more evident below. Therefore, the jib 46 is angularly displaceable from the boom 38 at the intersecting point 48. The intersecting point 48 is shown located generally midway along the boom 38. However, it should be understood that the intersecting point 48 can be positioned in other locations along the boom 38, including proximate to the mast 32.

The jib 46 includes a primary member 50 and a secondary member 52. The secondary member 52 pivots relative to the primary member 50 at pivot point 54. The primary member 50 is supported by a primary adjuster 56 and the secondary member 52 is supported by a secondary adjuster 58. The primary adjuster 56 is contemplated to be a cable or the like which is adjusted by a motorized winch (not shown) or equivalent as is known to those of ordinary skill in the art. Alternatively, the primary adjuster 56 is controlled by a hydraulic cylinder (also not shown). The primary adjuster 56 extends from the boom 38 and extends or retracts to control the angular relationship between the jib 46 and the boom 38.

The secondary adjuster 58 controls the angular relationship between the primary member 50 and the secondary member 52 in a similar manner as the primary adjuster 56 controls the angular relationship between the primary member 50 and the boom 38. As such, the secondary adjuster 58 is contemplated to be a cable controlled by a motorized winch (not shown) or equivalent. In the alternative, the secondary adjuster is controlled by a hydraulic cylinder located at pivot point 54.

The boom 38 is a structural support boom capable of lifting heavy construction components to increasing elevated heights of the hyperbolic cooling tower 10 in addition to supporting the jib 46. The boom 38 rotates around axis a, and, therefore, mast 32 by way of a turntable 60. The turntable 60 rotates the boom 38, and therefore the jib 46, a full 360° providing full rotational access to the annular wall 12 of the cooling tower 10. Therefore, it is not necessary to continually reverse the rotational direction of the boom 38 in an effort to provide concrete mixture to the full circumference of the annular wall 12 as is required by known prior art concrete delivery devices.

A secondary pipeline 62 extends from the primary pipeline 36 along the boom 38 to the jib 46. The secondary pipeline 62 traverses the primary member 50 and the secondary member 52 to deliver the concrete mixture to a delivery hose 64 that extends beyond a distal end of the jib 46. The delivery hose 64 is flexible so that an operator can position the outlet of the hose 64 where desired to deliver the concrete mixture into the formwork. The secondary pipeline 62 includes pipe joints (not shown) located proximate intersecting point 48 and pivot point 54 so that the secondary pipeline 62 bends to match the angular displacement between the boom 38, the first member 50 and the second member 52 of the jib 46.

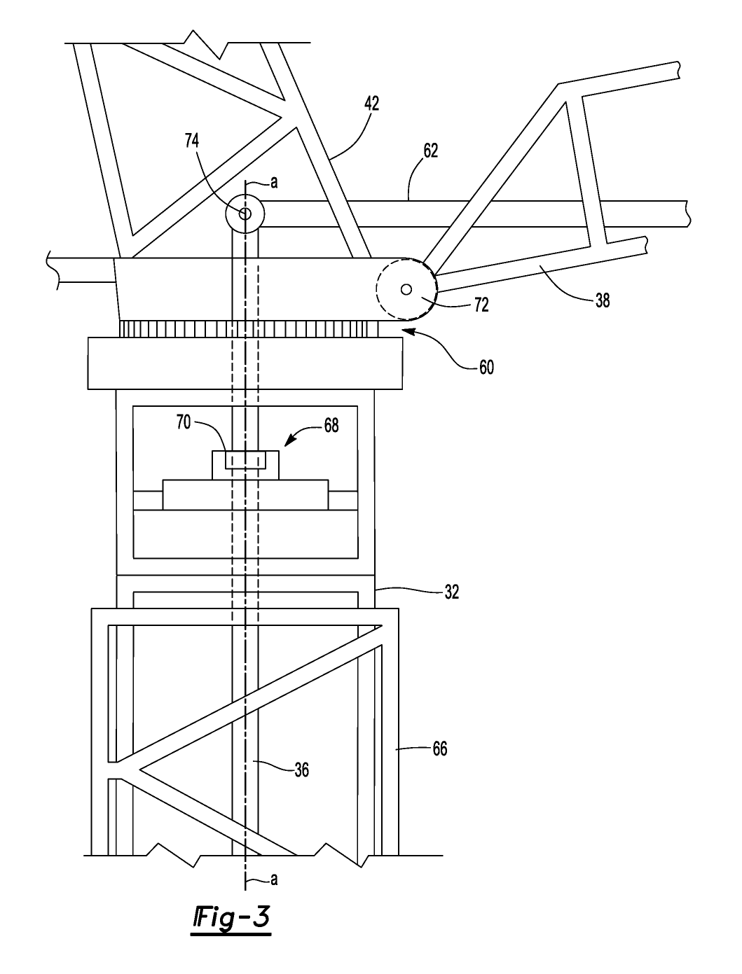

Referring now to FIG. 3, the interaction between the primary pipeline 36 and the secondary pipeline 62 will now be explained. The mast 32 is surrounded by a climbing assembly 66. As is known to those of skill in the art, the climbing assembly 66 is used when increasing the height of the mast to correspond to the increasing height of the hyperbolic cooling tower 10. The primary pipeline 36 is mated to the secondary pipeline 62 by way of a mating joint generally shown at 68. The mating joint 68 includes a rotational bearing assembly 70. The rotational bearing assembly takes the form of a friction joint having pipe flanges mated with a collar. Ball bearings are included if necessary to facilitate rotation of the secondary pipeline 62 relative to the primary pipeline 36. The rotational bearing 70 enables the secondary pipeline 62 to pivot freely relative to the primary pipeline 36 around axis a. This allows the secondary pipeline 62 to rotate continuously through a full 360° around the mast 32 along with the boom 38 and jib 46. The turntable 60 is motorized to drive the boom 38 circumferentially to distribute the concrete mixture where desired around the annular wall 12 of the hyperbolic cooling tower 10.

The boom 38 is mated to the turntable assembly 60 by turntable pivot 72 to facilitate the adjustment of the angular relationship between the boom 38 and the mast 32. To allow the secondary pipeline 62 to pivot in an angle relative to the mast 32 along with the boom 38, the secondary pipeline 62 includes pipeline joint 74 that allows the secondary pipeline 62 to pivot relative to the primary pipeline 36. Therefore, the delivery hose 64 is raised and lowered relative to the height of the wall 12 of the hyperbolic cooling tower 10 so that the concrete mixture is delivered to the desired height and radial distance from the axis a of the tower 10.

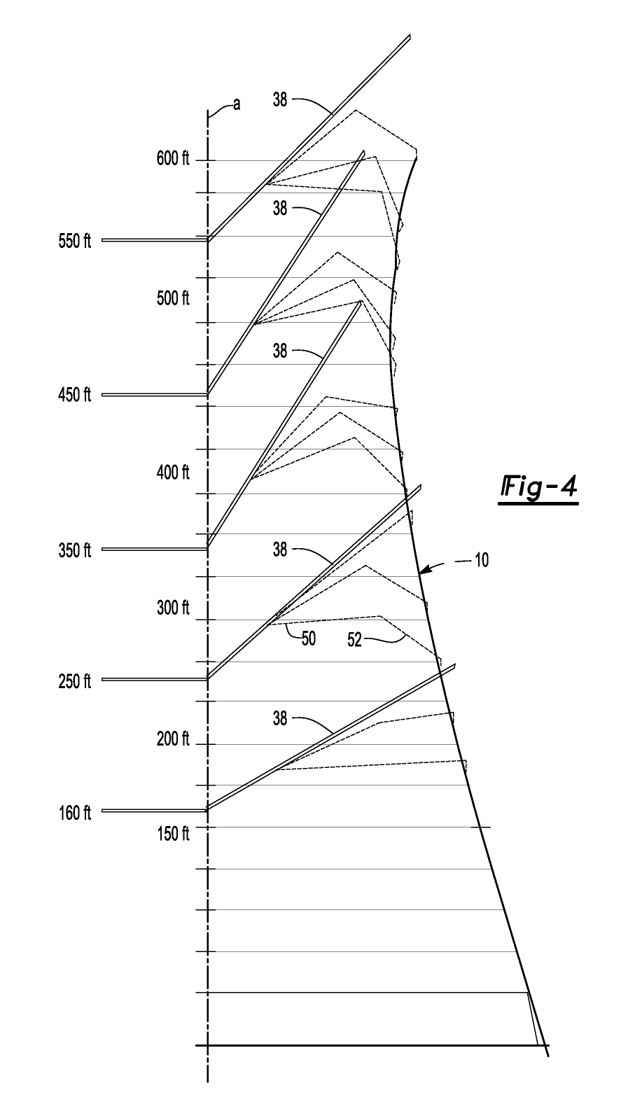

Referring now to FIG. 4, a schematic representation of the improved accuracy of delivering concrete mixture to the wall 12 of the hyperbolic cooling tower 10 is shown. It should be evident to one of ordinary skill in the art that the improved geometric configuration of the crane assembly 30 of the present invention reduces the number of times the height of the mast 32 is increased so that the delivery hose 64 can deliver the concrete mixture to a wide range of incrementally increasing heights of the wall 12.

A typical tower 10 that rises to a height of 600 feet is represented in FIG. 4. However, it should also be understood that towers having different heights can be constructed with the apparatus and method of the present application. The serrated lines of FIG. 4 represent the jib 46 along with the primary and secondary members 50, 52. Taking, for example, the crane assembly height of 250 feet, it should be apparent that the angular relationship between the primary and secondary members 50, 52, with the boom 38 provides the ability for the conveyance pipeline 62 to deliver concrete mixture to a tower 10 range of heights of 250 to 350 feet. It should also be apparent that the radial distance concrete mixture is capable of being delivered by the delivery hose 64 is easily revised by adjusting the angular relationship between the jib 46 and the mast 32 along with the angular relationship between the primary member 50, the secondary member 52, and the delivery hose 64. It should be understood that there may be geometric configurations of a cooling tower where a single fixed-length jib is substituted for the primary member 50 and secondary member 52. This alternative jib arrangement may provide a more economical option where the transition of the overall geometry is less severe and the flexibility of a two-piece jib is not required.

It should be further understood that because each of the components of the crane assembly 30 are mechanically operated by way of a mechanical winch or hydraulic cylinder that manual adjustment of the location of the conveyance pipeline 64 is limited, particularly when compared to known prior art assemblies used to deliver concrete mixtures to elevated structures. As set forth above, the intersecting point 48 of the jib 46 to the boom 38 can be located at different spaced positions from the mast 32. For example, the intersecting point 48 can be positioned immediately adjacent the turntable pivot 72. Although this is believed to add additional mass to the boom 38, it is believed that a reduction of the number of times the height of the crane assembly 30 is adjusted is achieved as shown in related U.S. Provisional Patent application No. 61/456,842. The location of the intersecting point 48 of the jib 46 to the boom 38 is dependent upon the geometric configuration of the hyperbolic cooling tower 10.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A crane assembly for delivering a concrete mixture to increasing heights of an elevated structure, comprising:
a primary pipeline receiving the concrete mixture from a source of the concrete mixture;
a mast supporting the primary pipeline in a substantially vertical orientation;
a boom extending radially outwardly from said mast, and a jib supported by said boom at an intersecting point of said boom to said mast;
a secondary pipeline rotationally affixed to said primary pipeline and extending radially outwardly from said primary pipeline along said boom to said jib; and
said secondary pipeline being pivotal around an axis of said mast along with said boom, with said jib being angularly displaceable from said boom at said intersecting point thereby directing said secondary pipeline to a location spaced from said primary pipeline.

2. The assembly set forth in claim 1, wherein said jib includes a primary member and a secondary member spaced from said boom by said primary member.

3. The assembly set forth in claim 2, wherein said secondary member is pivotally affixed to a distal end of said primary member providing additional degrees of radial separation from a distal end of said jib and said mast.

4. The assembly set forth in claim 1, wherein said secondary pipeline includes a delivery hose extending beyond said jib for delivering the concrete mixture to the elevated structure.

5. The assembly set forth in claim 1, wherein an amount of angular displacement of said jib from said boom is controllable by an adjuster.

6. The assembly set forth in claim 1, wherein said adjuster comprise a first cable affixed to said first member and a second cable affixed to said second member, a length of each of said cables being independently adjustable for varying the amount of separation from a distal end of said jib and said mast.

7. The assembly set forth in claim 1, wherein said second pipeline is pivotally connected to said first pipeline at a rotational bearing assembly.

8. The assembly set forth in claim 1, wherein said boom provides a continuous 360° degrees of rotation around said mast.

9. The assembly set forth in claim 1, wherein said boom is a structural boom capable of lifting construction components to increasing elevated heights of the structure.

10. A method of delivering a concrete mixture to increasing heights of an elevated structure, comprising the steps of:
providing a crane assembly supporting a pipeline for delivering a concrete mixture to increasing heights of the elevated structure, said crane assembly including a mast supporting a boom and a jib supported by said boom;
adjusting the angular relationship between said boom and said jib for delivering the concrete mixture to different radial distances from said crane assembly;
raising an elevation of said boom to deliver the concrete mixture to the increasing heights of the elevated structure.

11. The method set forth in claim 10, further including the step of rotating said boom continuous 360° relative to said tower thereby delivering concrete mixture through said pipeline to a full circumferential arrangement of said structure.

12. The method set forth in claim 10, wherein said step of providing a jib supported by said boom is further defined by providing said jib with a first member pivotally affixed to said boom and a second member pivotally affixed to an opposite end of said first member from said boom.

13. The method set forth in claim 10, further including the step of lifting manufacturing components to elevated heights of the structure with said boom.

14. The method set forth in claim 10, wherein said step of delivering the concrete mixture to increasing heights of the elevated structure is further defined by transporting the concrete mixture over said boom to said jib.

15. The method set forth in claim 12, wherein said step of delivering concrete mixture to different radial distances from said crane assembly is further defined by adjusting an angular relationship between said first member and said second member.

16. The method set forth in claim 10, wherein said step of providing a pipeline is further defined by providing a primary pipeline and a secondary pipeline pivotal relative to said primary pipeline thereby delivering the concrete mixture to different circumferential locations of the elevated structure.

17. The method set forth in claim 16, further including the step of providing a delivery hose extending from said secondary pipeline beyond a distal end of said jib for delivering the concrete mixture to different radial distances from said crane assembly.

18. The method set forth in claim 16, further including the step of pivoting said secondary pipeline a continuous 360° rotation relative to said primary pipeline.

19. The method set forth in claim 16, further including the step of adjoining said primary pipeline to said secondary pipeline with a bearing assembly thereby allowing said secondary pipeline to rotate a continuous 360° relative to said primary pipeline.

20. The method set forth in claim 10, further including the step of providing a fixed length jib supported by said boom for delivering concrete mixture to a predetermined geometric shape of the elevated structure.
